(19) United States
(12) Patent Application Publication
(10) Pub. No.: US 2025/0337136 A1
(43) Pub. Date: Oct. 30, 2025

(54) SECONDARY BATTERY, BATTERY PACK, AND ENERGY STORAGE BOX

(71) Applicants: ZHEJIANG JINKO ENERGY STORAGE CO., LTD., Jiaxing (CN); ZHEJIANG JINKO SOLAR CO., LTD., Haining (CN)

(72) Inventors: Xianrong ZENG, Jiaxing (CN); Yuhao WU, Jiaxing (CN)

(21) Appl. No.: 18/797,382

(22) Filed: Aug. 7, 2024

(30) Foreign Application Priority Data
Apr. 28, 2024 (CN) 202410523862.6
Apr. 28, 2024 (CN) 202410524295.6

(51) Int. Cl. H01M 50/567; H01M 50/15; H01M 50/188; H01M 50/533; H01M 50/553; H01M 50/588; H01M 50/59

(52) U.S. Cl. CPC H01M 50/567; H01M 50/15; H01M 50/188; H01M 50/533; H01M 50/553; H01M 50/59

(57) ABSTRACT

The present disclosure provides a secondary battery, a battery pack, and an energy storage box. The secondary battery includes an end cover assembly. The end cover assembly includes a top cover, a top patch, and an electrode terminal. The end cover assembly is designed to have a more compact structure, which reduces a space occupied, thereby improving a capacity and energy density of the secondary battery.

### CROSS-REFERENCE TO RELATED APPLICATIONS

The present application claims priority to Chinese Patent Application No. 202410524295.6, filed on Apr. 28, 2024, and Chinese Patent Application No. 202410523862.6, filed on Apr. 28, 2024, the content of which are incorporated herein by reference in its entirety.

### TECHNICAL FIELD

The present disclosure relates to the technical field of batteries, and in particular, to a secondary battery, a battery pack, and an energy storage box.

### BACKGROUND

A secondary battery is a rechargeable battery that can be reused and have reversibility and is a reversible battery that can continue to be used by recharging after the battery is discharged. With the continuous development of photovoltaic and other power generation technologies, there is a need to collect power generated from clean energy for subsequent use. A battery capacity is an important performance indicator of the secondary battery, but due to a battery structure, it is difficult to continue to increase the capacity of the current secondary battery.

### SUMMARY

In view of this, the present disclosure provides a secondary battery, a battery pack, and an energy storage box to help solve the problems of a small capacity and low energy density of the secondary battery in the prior art.

The present disclosure provides a secondary battery, wherein the secondary battery includes an end cover assembly, the end cover assembly including:
a top cover, the top cover having a first recessed portion, the first recessed portion being recessed along a height direction of the secondary battery, and a bottom wall of the first recessed portion having a first mounting hole;
a top patch, the top patch being connected to the top cover and located on a side of the end cover assembly away from interior of the secondary battery;
an electrode terminal, at least part of the electrode terminal sleeving the first mounting hole, and a protruding height of an upper surface of the electrode terminal relative to the top patch being H1, where 0<H1≤2 mm;

a second fixing member, the second fixing member sleeving the electrode terminal, and the second fixing member being made of an insulating material;

a connection sheet, the connection sheet being located on a side of the top cover away from the electrode terminal, and the connection sheet being connected to the electrode terminal; and

a sealing member, the sealing member being arranged along a circumferential direction of the electrode terminal;

the end cover assembly including a first fixing member, the first fixing member sleeving the second fixing member and being welded to the top cover to limit the electrode terminal, the electrode terminal and the first fixing member being located on two sides of the second fixing member respectively, the electrode terminal including a main body and a flange, the flange being arranged along a circumferential direction of the main body portion, the second fixing member abutting against the flange, the connection sheet having a protruding portion, the protruding portion protruding in a direction close to the electrode terminal, the protruding portion passing through the first mounting hole and being connected to the electrode terminal, or the electrode terminal being mounted on the top cover through a third fixing member, the third fixing member being located on a side of the top cover away from the top patch and sleeving the electrode terminal, the second fixing member being arranged on a side of the top cover facing the top patch and extending into the first recessed portion, the second fixing member including an extending portion, the extending portion extending along a thickness direction of the end cover assembly and being arranged along the circumferential direction of the electrode terminal, and at least part of the extending portion extending into the first mounting hole and being located between the electrode terminal and a hole wall of the first mounting hole.

In some embodiments, a protruding height of the electrode terminal relative to the top cover is H2, where 0.5 mm≤H2≤4 mm.

In some embodiments, the end cover assembly further includes a lower plastic member, the lower plastic member being located between the top cover and the third fixing member and sleeving the electrode terminal;
the lower plastic member having a second recessed portion, the second recessed portion being recessed in a direction away from the top cover to accommodate the first recessed portion.

In some embodiments, a bottom wall of the second recessed portion has a second mounting hole, the first mounting hole is in communication with the second mounting hole, the lower plastic member sleeves the electrode terminal through the second recessed portion, and the sealing member is arranged along the circumferential direction of the electrode terminal and is located between the electrode terminal and a side wall of the second recessed portion.

In some embodiments, the connection sheet has an accommodating portion, the accommodating portion being arranged along a circumferential direction of the protruding portion, the accommodating portion being recessed in a direction away from the electrode terminal, and the second recessed portion abuts against the accommodating portion.

In some embodiments, a side wall of the second fixing member has an avoidance groove, and at least part of the first fixing member is located in the avoidance groove.

In some embodiments, the second fixing member has a supporting portion, the supporting portion extending along the height direction of the secondary battery, the supporting portion abutting against the first recessed portion, and the flange is located on an inner side of the supporting portion.

In some embodiments, the end cover assembly includes a sealing member, the sealing member beings located between the electrode terminal and the first recessed portion.

In some embodiments, an inner wall of the second fixing member has a first limiting surface, and a side wall of the main body has a second limiting surface, the first limiting surface abutting against the second limiting surface.

In the secondary battery provided in the present disclosure, the secondary battery includes an end cover assembly. The end cover assembly includes a top cover, a top patch, and an electrode terminal. The top cover has a first recessed portion. The first recessed portion is recessed along a height direction of the secondary battery. A bottom wall of the first recessed portion has a first mounting hole. The top patch is connected to the top cover. The electrode terminal includes a main body and a flange. The flange is arranged along a circumferential direction of the main body portion. The flange is mounted on the first recessed portion. A protruding height of the main body relative to the top patch is H1, where 0<H1≤2 mm. The secondary battery further includes a first fixing member, a second fixing member, and a connection sheet. The second fixing member is made of an insulating material, sleeves the electrode terminal, and abuts against the flange. The first fixing member sleeves the second fixing member and is welded to the top cover. The connection sheet is located on a side of the top cover away from the electrode terminal. The connection sheet has a protruding portion. The protruding portion protrudes in a direction close to the electrode terminal. The protruding portion passes through the first mounting hole and is connected to the electrode terminal. The end cover assembly has a compact structure, which helps increase a battery capacity.

In some embodiments, along the thickness direction of the end cover assembly, an upper surface of the electrode terminal is higher than an upper surface of the top cover, and a distance between the upper surface of the electrode terminal and the upper surface of the top cover is no more than 3 mm.

In some embodiments, the secondary battery further includes a connection sheet and a cell assembly, the cell assembly including a tab, and the electrode terminal is electrically connected to the tab through the connection sheet; and
the connection sheet being provided with an accommodating portion, the accommodating portion being recessed along a direction away from the end cover assembly, the electrode terminal extends into the accommodating portion along the thickness direction of the end cover assembly and is connected to an inner wall of the accommodating portion.

In some embodiments, the cell assembly includes a first cell and a second cell, the first cell having a first tab, the second cell having a second tab, and the connection sheet includes an electrode terminal connection portion, a first tab connection portion, and a second tab connection portion, the first tab connection portion being electrically connected to the first tab, and the second tab connection portion being electrically connected to the second tab; and
along a width direction of the end cover assembly, the first tab connection portion and the second tab connection portion being located on two opposite sides of the electrode terminal connection portion, the accommodating portion being arranged on a side of the electrode terminal connection portion facing the electrode terminal, and a side of the electrode terminal connection portion facing the cell assembly protruding at a position corresponding to the accommodating portion.

In some embodiments, along the thickness direction of the end cover assembly, a depth of the accommodating portion ranges from 3 mm to 6 mm.

In some embodiments, the electrode terminal includes a limiting section and a riveting section connected to each other, a cross-sectional area of the limiting section being greater than a cross-sectional area of the riveting section, the limiting section being located at an end of the electrode terminal away from the interior of the secondary battery, the cross-sectional area of the limiting section being greater than a cross-sectional area of the first mounting hole, and part of the riveting section passing through the first mounting hole and sleeving the third fixing member.

In some embodiments, one side of the third fixing member away from the top cover has an accommodating groove, and a side of the riveting section away from the limiting section is provided with a limiting portion, the limiting portion being arranged along a circumferential direction of the riveting section and protruding relative to the riveting section, and the accommodating groove being configured to accommodate the limiting portion.

In some embodiments, a distance between the limiting portion and an end face on the side of the riveting section away from the limiting section is d, where 0≤d≤3 mm; and
the limiting portion fits a side wall of the accommodating groove.

In some embodiments, the end cover assembly further includes a lower plastic member, the lower plastic member being located between the top cover and the third fixing member and sleeving the electrode terminal;
the lower plastic member having a second recessed portion, the second recessed portion being recessed in a direction away from the top cover to accommodate the first recessed portion; and
the lower plastic member sleeving the electrode terminal through the second recessed portion, and the sealing member is arranged along the circumferential direction of the electrode terminal and is located between the electrode terminal and a side wall of the second recessed portion.

In some embodiments, along the height direction of the secondary battery, the sealing member abuts against the extending portion.

In some embodiments, the top patch has an opening, the opening having a turnup at an edge, the turnup extending along the height direction of the secondary battery, the turnup being arranged around the electrode terminal, and the turnup being capable of covering part of a side wall of the electrode terminal.

In a second aspect of the present disclosure, a battery pack is provided, wherein the battery pack includes at least one battery module, the battery module including at least one secondary battery;
wherein the secondary battery is the secondary battery in any one of the above embodiments.

In a third aspect of the present disclosure, an energy storage box is provided, wherein the energy storage box includes an inverter, a battery management system (BMS), and at least one battery pack, wherein the battery pack is the battery pack as described above.

The present disclosure provides a secondary battery, a battery pack, and an energy storage box. The secondary battery includes an end cover assembly and a top patch. The end cover assembly includes a top cover and an electrode terminal. The electrode terminal is mounted on the top cover. The electrode terminal may be riveted to the top cover through a third fixing member. The top patch is located on a side of the end cover assembly away from interior of the secondary battery. The top cover is provided with at least one first recessed portion. A bottom wall is provided with a mounting hole. The electrode terminal sleeves the first mounting hole. A sealing member is arranged along a circumferential direction of the electrode terminal. The third fixing member is arranged on a side of the top cover away from the top patch, and sleeves the electrode terminal. The electrode terminal protrudes within 2 mm of the top patch. A second fixing member sleeves a side of the electrode terminal facing the top patch. An extending portion of the second fixing member extends along a thickness direction of the end cover assembly and is arranged along the circumferential direction of the electrode terminal. At least part of the extending portion extends into the first mounting hole is located between the electrode terminal and a hole wall of the mounting hole. The second fixing member is made of an insulating material. Through such a design, the end cover assembly can be more compact in structure, which reduces a space occupied by the end cover assembly, thereby helping increase a capacity and energy density of the secondary battery.

### BRIEF DESCRIPTION OF DRAWINGS

In order to more clearly illustrate the technical solutions in embodiments of the present disclosure, the accompanying drawings to be used in the description of the embodiments will be briefly introduced below. Obviously, the accompanying drawings described below are only some embodiments of the present disclosure. For those of ordinary skill in the art, other accompanying drawings can also be obtained from the provided drawings without creative efforts.

FIG. 1 is a schematic structural diagram of a secondary battery according to some embodiments of the present disclosure;

FIG. 2 is a cross-sectional view of an end cover assembly according to some embodiments of the present disclosure;

FIG. 3 is a cross-sectional view of the end cover assembly according to some embodiments of the present disclosure;

FIG. 4 is a partial cross-sectional view of the end cover assembly according to some embodiments of the present disclosure;

FIG. 5 is a partial cross-sectional view of the end cover assembly according to some embodiments of the present disclosure;

FIG. 6 is a structural diagram of a connection sheet according to some embodiments of the present disclosure;

FIG. 7 is an exploded view of the end cover assembly according to some embodiments of the present disclosure;

FIG. 8 is a schematic structural diagram of mounting and fitting between a second fixing member and an electrode terminal according to the present disclosure;

FIG. 9 is a schematic structural diagram of a cell assembly according to some embodiments of the present disclosure;

FIG. 10 is a partial exploded view of the secondary battery according to the present disclosure;

FIG. 11 is a schematic diagram of a top cover according to the present disclosure;

FIG. 12 is a partial sectional view of the secondary battery according to the present disclosure;

FIG. 13 is a partial sectional view of the secondary battery according to the present disclosure from another perspective;

FIG. 14 is a schematic diagram of the connection sheet according to the present disclosure;

FIG. 15 is a sectional view of the end cover assembly and the connection sheet according to the present disclosure;

FIG. 16 is a schematic diagram of a limiting portion according to some embodiments of the present disclosure;

FIG. 17 is a schematic diagram of the limiting portion according to some embodiments of the present disclosure;

FIG. 18 is a schematic diagram of the limiting portion according to some embodiments of the present disclosure;

FIG. 19 is a schematic diagram of a lower plastic member according to the present disclosure;

FIG. 20 is a schematic diagram of the secondary battery according to the present disclosure;

FIG. 21 is a schematic diagram of the limiting portion according to some embodiments of the present disclosure;

FIG. 22 is a schematic diagram of the secondary battery according to some embodiments of the present disclosure;

FIG. 23 is a schematic diagram of the secondary battery according to some embodiments of the present disclosure;

FIG. 24 is a schematic diagram of a battery pack according to the present disclosure;

FIG. 25 is an exploded view of the battery pack according to the present disclosure; and

FIG. 26 is a schematic diagram of an energy storage box according to the present disclosure.

### REFERENCE SIGNS

1: end cover assembly;
   11: top cover;
      111: first recessed portion;
      112: first mounting hole;
   12: top patch;
      121: thermally conductive member;
      122: turnup;
      123: bending portion;
   13: electrode terminal;
      131: main body portion;
      132: flange;
      133: second limiting surface;
      134: limiting groove;
      135: limiting section;
      136: riveting section;
         136a: limiting portion;
   14: first fixing member;
   15: connection sheet;
      151: protruding portion;
      152: accommodating portion;
      153: electrode terminal connection portion;
         153a: first tab connection portion;
         153b: second tab connection portion;
   16: lower plastic member;
      161: second recessed portion;
      162: second mounting hole;
   17: second fixing member;
      171: avoidance groove;
      172: supporting portion;
      173: first limiting surface;
      174: extending portion;
   18: sealing member;
2: cell assembly;
   21: first cell;
      211: first tab;
   22: second cell;
      221: second tab;
   3: battery pack;
   4: energy storage box;
   5: third fixing member;
   51: accommodating groove;
   6: busbar;
   7: battery module.

### DESCRIPTION OF EMBODIMENTS

In order to better understand the technical solution of the present disclosure, embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the scope of protection of the present disclosure.

The terms used in the embodiments of the present disclosure are intended only to describe specific embodiments and are not intended to limit the present disclosure. As used in the embodiments of the present disclosure and the appended claims, the singular forms of “a/an”, “one”, and “the” are also intended to include plural forms, unless otherwise clearly specified in the context.

It should be understood that the term “and/or” used herein describes only an association relationship between associated objects and represents that three relationships may exist. For example, A and/or B may represent the following three cases: only A exists, both A and B exist, and only B exists. In addition, the character “/” generally indicates an “or” relationship between the associated objects.

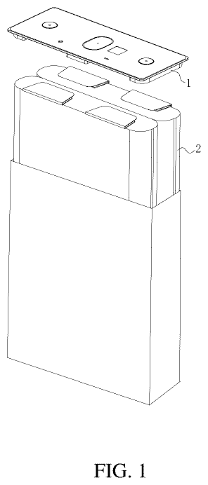

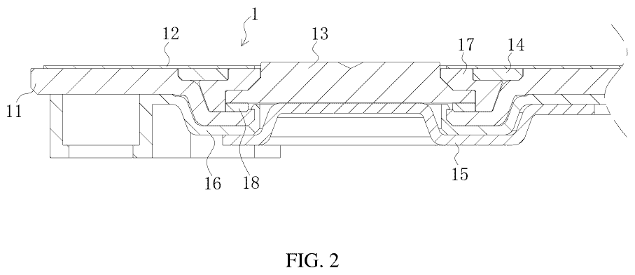

As shown in FIG. 1 and FIG. 2, some embodiments of the present disclosure provide a secondary battery. The secondary battery includes an end cover assembly 1 and a shell (not shown). The shell is configured to accommodate a cell assembly 2 and electrolyte. The end cover assembly 1 fits the shell to close and isolate an internal structure of the battery. The end cover assembly 1 includes a top cover 11, a top patch 12, an electrode terminal 13, a first fixing member 14, and a second fixing member 17. The top cover 11 is configured to support the end cover assembly 1 as a whole, and at the same time, may close an opening provided in the shell when fitting the shell. The top cover 11 may be made of a metal material, so as to have sufficient mechanical strength and be easy to machine, which may be made of, for example, aluminum, an aluminum alloy, stainless steel, or the like. The top patch 12 fits a side of the top cover 11 away from the shell. The top patch 12 is configured for protection and insulation to prevent a battery short circuit caused by a connection between the top cover 11 and an external circuit.

The top cover 11 has a first recessed portion 111. A bottom wall of the first recessed portion 111 has a first mounting hole 112. The first mounting hole 112 passes through the bottom wall of the first recessed portion 111 along a thickness direction of the end cover assembly 1. The first recessed portion 111 is recessed in a direction close to interior of the shell. When mounted in the first recessed portion 111, the electrode terminal 13 can sink in a direction close to the cell assembly 2, thereby reducing a protruding height of the electrode terminal 13 relative to the top patch 12. In an embodiment, a protruding height of the top of the electrode terminal 13 relative to the top of the top patch 12 is H1, where 0<H1≤12 mm. For example, H1 may be 0.1 mm, 0.2 mm, 0.3 mm, 0.4 mm, 0.5 mm, 0.6 mm, 0.7 mm, 0.8 mm, 0.9 mm, 1.0 mm, 1.3 mm, 1.5 mm, 1.7 mm, 2 mm, or the like. If a height dimension of the electrode terminal 13 is reduced, an overall thickness of the end cover assembly 1 can be reduced, thereby reducing a proportion of the end cover assembly 1 in an overall height of the secondary battery, which helps increase volumes of the shell and the cell assembly 2 when an overall volume of the secondary battery is fixed and increase a capacity of the battery, so that the battery has higher energy density. The electrode terminal 13 includes a main body 131 and a flange 132 arranged along a circumferential direction of the main body 131. The electrode terminal 13 is limited through the flange 132. The flange 132 is located at the bottom of the main body 131 and is mounted in the first recessed portion 111. The end cover assembly 1 further includes a first fixing member 14 and a second fixing member 17. The second fixing member 17 sleeves the main body 131 and abuts against the flange 132. The first fixing member 14 sleeves the second fixing member 17 and is fixedly connected to the top cover 11. The first fixing member 14 may be made of a metal material such as stainless steel, aluminum, or an aluminum alloy, or made of a ceramic material, and is fixedly connected to the top cover 11 by welding or the like. The first fixing member 14 can press down the second fixing member 17 when fixed, and the second fixing member 17 can further press down and fix the flange 132, so that the electrode terminal 13 is stably mounted in the first recessed portion 111. The top cover 11 is provided with a plurality of openings configured to arrange a liquid injection hole and an explosion-proof valve. Corresponding to the top cover 11, the top patch 12 is provided with an opening to facilitate arrangement of the explosion-proof valve and the liquid injection hole. The top patch 12 is further provided with an opening to avoid the electrode terminal 13, and the top patch 12 covers at least part of the second fixing member 17. The top patch 12 has the opening to avoid the electrode terminal 13, and a distance from an edge of the opening to the electrode terminal 13 ranges from 0.5 mm to 3 mm to prevent an influence of the top patch 12 on operation of the electrode terminal 13. A side of the top patch 12 away from the top cover 11 further has an identification code. The identification code may be a specific identification pattern, such as a barcode or a QR code, which facilitates identification and tracing of the secondary battery through other devices.

In the embodiments of the present disclosure, the electrode terminal 13 is mounted and fixed by laminating the first fixing member 14 and the second fixing member 17 to each other, which facilitates machining and fitting and has a stable structure. The second fixing member 17 is made of an insulating material. For example, the second fixing member 17 may be made of plastic, silicone, rubber, or the like. The second fixing member 17 is configured to isolate the electrode terminal 13 from the first fixing member 14. The second fixing member 17 insulates and protects the electrode terminal 13 to prevent a short circuit caused by contact between the electrode terminal 13 and the top cover 11. Moreover, the second fixing member 17 has certain elasticity. When the first fixing member 14 presses down and fixes the second fixing member 17, the second fixing member 17 can elastically deform and closely fit the electrode terminal 13 to achieve a stable fixing effect on the electrode terminal 13.

The top cover 11 further includes a connection sheet 15. The connection sheet 15 is located at the bottom of the electrode terminal 13 and is configured to connect the tab of the cell and the electrode terminal 13. An external device is connected to the tab to realize an electrical connection with the cell. The connection sheet 15 has a protruding portion 151. The protruding portion 151 protrudes in a direction close to the electrode terminal 13. The protruding portion 151 is connected to the electrode terminal 13. A projection of the protruding portion 151 along the thickness direction of the end cover assembly 1 may be in a shape of a circle, an oval, a rectangle, or the like, as long as the connection with the electrode terminal 13 can be achieved, which is not limited herein. The connection sheet 15 has the protruding portion 151, and in some embodiments of the present disclosure, when a height of the electrode terminal 13 is appropriately reduced, the connection sheet 15 can also be stably connected to the electrode terminal 13. Therefore, dimensions and a volume of the electrode terminal 13 can be reduced, machining and manufacturing costs can be saved, and the thickness of the end cover assembly 1 can be reduced, making it easier to arrange the cell assembly 2 and the shell with larger sizes, thereby increasing energy density of the secondary battery. Therefore, the end cover assembly 1 provided in the embodiments of the present disclosure has a compact structure, and it is easy to increase the volume of the shell by reducing the thickness of the end cover assembly 1, thereby increasing the capacity and the energy density of the secondary battery.

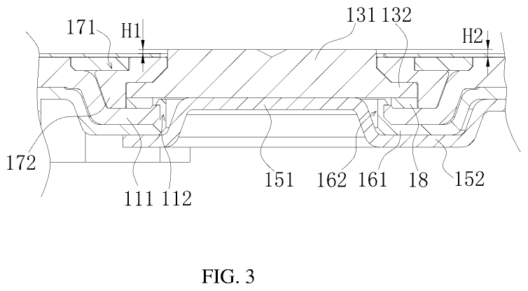

As shown in FIG. 3, in some embodiments, a protruding height of the electrode terminal 13 relative to the top cover 11 is H2, where 0.5 mm≤H2≤4 mm. By controlling the protruding height of the electrode terminal 13 relative to the top cover 11, it is easy to reduce occupation of the overall height of the secondary battery by the electrode terminal 13 and to control the overall thickness of the end cover assembly 1, so that more height space of the secondary battery is used to increase the capacity, thereby increasing the energy density of the secondary battery.

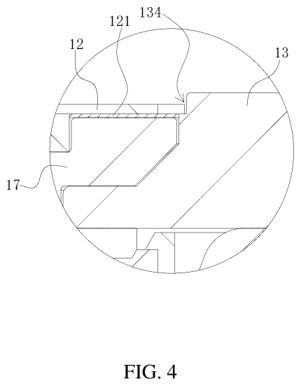

As shown in FIG. 4, in some embodiments, a side wall of the electrode terminal 13 has a limiting groove 134, and the limiting groove 134 is recessed towards interior of the electrode terminal 13 along a radial direction of the electrode terminal 13. Part of the top patch 12 extends into the limiting groove 134 and abuts against a bottom wall of the limiting groove 134. The top patch 12 can cover the second fixing member 17 and improve sealing performance of the top patch 12, thereby improving overall safety of the secondary battery. The limiting groove 134 may be provided in a stepped shape, and the top patch 12 may overlap with the bottom wall of the limiting groove 134, which facilitates the arrangement and mounting of the top patch 12.

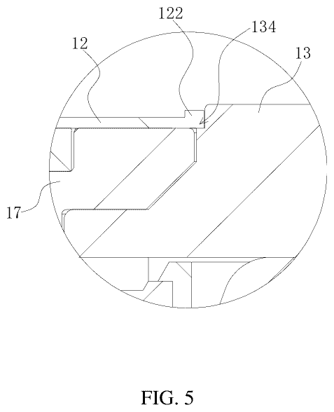

As shown in FIG. 5, in some embodiments, the top patch 12 has an opening to avoid the electrode terminal 13, the opening has a turnup 122 at an edge, the turnup 122 extends along the height direction of the secondary battery, the turnup 122 is arranged around the electrode terminal 13, and the turnup 122 is capable of covering part of a side wall of the electrode terminal 13. The turnup 122 can improve sealing performance of the top patch 12 and prevent entry of foreign matter into the end cover assembly from between the electrode terminal 13 and the top patch 12.

As shown in FIG. 4, in some embodiments, a side of the top patch 12 close to the top cover 11 is provided with a thermally conductive member 121. The thermally conductive member 121 is made of a material with higher thermal conductivity and is configured to conduct heat generated by the electrode terminal 13, thereby improving heat dissipation efficiency of the electrode terminal 13 and preventing an influence on normal operation of the electrode terminal 13 due to an excessively high temperature. In an embodiment, the thermally conductive member 121 is arranged between the top patch 12 and the second fixing member 17, one end of the thermally conductive member 121 abuts against the electrode terminal 13, and heat generated by the electrode terminal 13 can be conducted to the thermally conductive member 121 and then be further diffused to the outside through the thermally conductive member 121. As shown in FIG. 2, in some embodiments, the end cover assembly 1 includes a lower plastic member 16, and the lower plastic member 16 is located on a side of the top cover 11 away from the top patch 12 and is connected to the top cover 11. The lower plastic member 16 is configured to encapsulate and connect the shell of the battery. The lower plastic member 16 can be tightly connected to the shell to achieve a good sealing effect, prevent entry of external impurities such as dust and moisture into the battery, prevent accidents such as corrosion or a short circuit inside the battery, and improve safety of the battery. The lower plastic member 16 may be made of a plastic material such as polypropylene (PP) or polystyrene (PP), which can achieve a good sealing effect, have corrosion resistance and heat resistance, and can meet a sealing function of the top cover 11.

As shown in FIG. 3, the lower plastic member 16 has a second recessed portion 161, the second recessed portion 161 is recessed in a direction away from the electrode terminal 13, and the first recessed portion 111 is mounted in the second recessed portion 161, so that the second recessed portion 161 sleeves the first recessed portion 111. The second recessed portion 161 can limit and support the first recessed portion 111, so that the top cover 11 and the lower plastic member 16 can be connected relatively stably. A bottom wall of the second recessed portion 161 has a second mounting hole 162. The first mounting hole 112 is in communication with the second mounting hole 162. The protruding portion 151 can pass through the second mounting hole 162 and the first mounting hole 112 and be connected to the electrode terminal 13. The lower plastic member 16 may be formed by injection molding or compression molding to be machined into a specific shape.

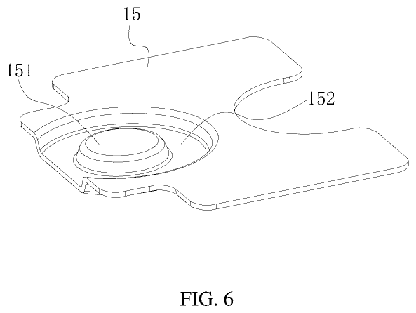

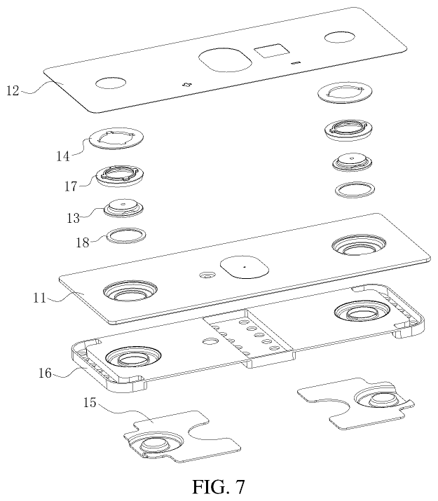

As shown in FIG. 6 and FIG. 7, in some embodiments, the connection sheet 15 has an accommodating portion 152, the accommodating portion 152 is arranged along a circumferential direction of the protruding portion 151, the accommodating portion 152 is recessed in a direction away from the electrode terminal 13, and the second recessed portion 161 abuts against the accommodating portion 152.

Except for a region provided with the second mounting portion, most other regions of the lower plastic member 16 are planar as a whole. The planar region has a connection portion. The connection portion fits the bottom of the lower plastic member 16. The connection portion is configured to connect to the tab. A connection sheet is provided with the protruding portion 151 and the accommodating portion 152 to facilitate the connection sheet to adapt to a shape of the lower plastic part 16 and to closely fit the lower plastic member 16. Through the arrangement of the protruding portion 151 and the accommodating portion 152, a cavity region generated between the connection sheet and the lower plastic member can be reduced, an internal space of the shell can be fully utilized, and the overall thickness of the end cover assembly 1 can be reduced, which reduces occupation of an internal space of the battery by the end cover assembly 1 and helps increase the volume of the shell and increase the capacity and the energy density of the secondary battery.

As shown in FIG. 3, in some embodiments, a side wall of the second fixing member 17 has an avoidance groove 171, and at least part of the first fixing member 14 is located in the avoidance groove 171.

The avoidance groove 171 is located on a top outer wall of the second fixing member 17 and is arranged along a circumferential direction of the second fixing member 17. The avoidance groove 171 is configured to avoid and support the first fixing member 14. When the first fixing member 14 sleeves and is mounted on the second fixing member 17, part of the first fixing member 14 extends into the avoidance groove 171, and a portion of the first fixing member 14 away from the second fixing member 17 extends out of the avoidance groove 171 and is connected and fixed to the top cover 11. The first fixing member 14 presses down a bottom wall of the avoidance groove 171 so as to achieve a pressing and fixing effect on the second fixing member 17. A side wall of the avoidance groove 171 can isolate the first fixing member 14 from the electrode terminal 13 to prevent a short circuit caused by contact between the electrode terminal 13 and other conductive parts of the battery.

As shown in FIG. 3, in some embodiments, the second fixing member 17 has a supporting portion 172, the supporting portion 172 extends along the height direction of the secondary battery, the supporting portion 172 abuts against the first recessed portion 111, and the flange 132 is located on an inner side of the supporting portion 172.

The supporting portion 172 extends along a circumferential direction of the flange 132 to increase a dimension of the second fixing member 17 in the thickness direction of the end cover assembly 1, so that the second fixing member 17 has a sufficient height dimension to completely cover a portion of the electrode terminal 13 located on an inner side of the top patch 12. The supporting portion 172 wraps part of the flange 132 and the main body 131 on an inner side thereof, so that the flange 132 and the main body 131 are completely isolated from the first fixing member 14. A height of the supporting portion 172 may be set according to an inner wall of the first recessed portion 111, so that the supporting portion 172 can fully fit the first recessed portion 111. When the first fixing member 14 sleeves and is mounted on the second fixing member 17, the top of the supporting portion 172 may be configured to support the first fixing member 14.

As shown in FIG. 2 and FIG. 3, in some embodiments, the end cover assembly 1 includes a sealing member 18, and the sealing member 18 is located between the electrode terminal 13 and the first recessed portion 111.

The sealing member 18 is configured to improve sealing performance of the end cover assembly 1. The electrolyte is required to be injected into the shell of the battery. The arrangement of the sealing member 18 between the electrode terminal 13 and the first recessed portion 111 can prevent leakage of the electrolyte inside the secondary battery from the first mounting hole 112 and the second mounting hole 162 and can also prevent entry of external gas or liquid into the secondary battery from the first mounting hole 112 and the second mounting hole 162, thereby improving reliability of the secondary battery. The sealing member 18 has certain elasticity and good insulating properties, so that the sealing member 18 can closely fit the electrode terminal 13 and a top wall of the first recessed portion 111. In addition, the electrolyte is required to be injected into the shell of the secondary battery, the electrolyte is corrosive to some extent, and the battery may generate a lot of heat when operating. Therefore, a sealing ring can withstand high temperatures and corrosion, and the sealing member 18 may be made of a material such as fluorine rubber, nitrile rubber, silicone rubber, or polyurethane. The height of the supporting portion 172 matches a height of the sealing member 18. The sealing member 18 is located at the bottom of the electrode terminal 13. A dimension of the supporting portion 172 should be at least the same as the heights of the flange 132 and the sealing member 18 so that the supporting portion 172 can completely enclose the flange 132 and the sealing member 18.

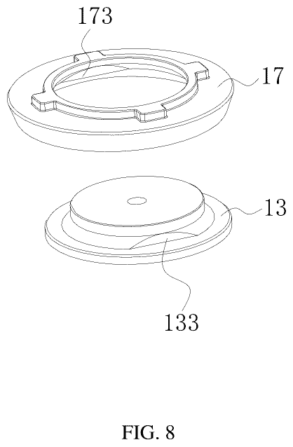

As shown in FIG. 8, in some embodiments, an inner wall of the second fixing member 17 has a first limiting surface 173, a side wall of the main body 131 has a second limiting surface 133, and the first limiting surface 173 abuts against the second limiting surface 133.

The inner wall of the second fixing member 17 has the first limiting surface 173 extending along the thickness direction of the end cover assembly 1. The first limiting surface 173 may be planar. An outer wall of the main body 131 has the second limiting surface 133 extending along the thickness direction of the end cover assembly 1. When the second fixing member 17 sleeves the main body 131, the first limiting surface 173 and the second limiting surface 133 may abut against each other. Since a cross section of the electrode terminal 13 along a length direction of the end cover assembly 1 is in a shape of a circle and the second fixing member 17 sleeves the electrode terminal 13, the electrode terminal 13 is prone to relative rotation with the second fixing member 17. Through the arrangement of the first limiting surface 173 and the second limiting surface 133, relative rotation of the electrode terminal 13 and the second fixing member 17 can be prevented, thereby improving stability of mounting of the electrode terminal 13.

As shown in FIG. 3 and FIG. 7, the electrode terminal 13 provided in the embodiments of the present disclosure includes a positive electrode terminal and a negative electrode terminal, and the positive electrode terminal and the negative electrode terminal are spaced apart along the length direction of the end cover assembly 1. Correspondingly, the top cover 11 is provided with two first recessed portions 111 to mount the positive electrode terminal and the negative electrode terminal respectively, and the lower plastic member 16 is correspondingly provided with two second mounting portions. The positive electrode terminal and the negative electrode terminal are each provided with the first fixing member 14 and the second fixing member 17 for corresponding fitting and mounting. The first fixing member 14 mounted on the positive electrode terminal and the first fixing member 14 mounted on the negative electrode terminal have differentiated designs in appearance. An inner side of the first fixing member 14 mounted on the positive electrode terminal has four protruding nails spaced part to form a shape of a “+” symbol, while an inner side of the first fixing member 14 mounted on the negative electrode terminal has two protruding nails spaced part to form a shape of a “−” symbol. Through such a differentiated design, positions of the positive electrode terminal and the negative electrode terminal of the secondary battery can be directly identified through the appearances, reducing a possibility of user's mis-operation. The second fixing members 17 arranged on the positive electrode terminal and the negative electrode terminal are each provided with grooves engaging with the protruding nails of the first fixing member 14 to limit the first fixing member 14 and prevent rotation of the first fixing member 14 relative to the second fixing member 17.

In some embodiments, the top cover 11 has an explosion-proof valve. The explosion-proof valve is located between the positive electrode terminal and the negative electrode terminal. The explosion-proof valve has a deformable diaphragm. The diaphragm has certain elasticity. When there is greater pressure inside the shell of the battery, the explosion-proof valve may be subject to greater gas pressure. When the pressure exceeds a critical value, rupture may occur and a pressure relief function is realized, thereby preventing explosion of the battery and improving safety performance of the battery. The lower plastic member 16 is correspondingly provided with a ventilation hole. The ventilation hole runs through the thickness direction of the lower plastic member 16, so that gas inside the battery can be discharged from a pressure relief valve through the ventilation hole, which facilitates the pressure relief valve to adjust air pressure on an inner wall of the shell of the battery. The top patch 12 is also correspondingly designed with an opening to avoid the explosion-proof valve.

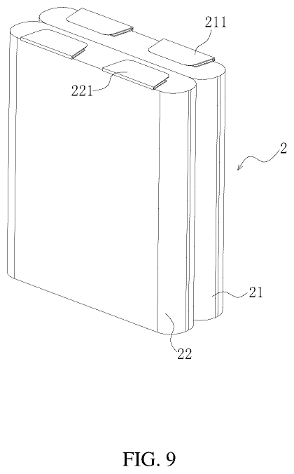

As shown in FIG. 9, in some embodiments, the secondary battery includes a cell assembly 2, the cell assembly 2 includes a first cell 21 and a second cell 22, the first cell 21 has a first tab 211, the second cell 22 has a second tab 221, and the first tab 211 and the second tab 221 are connected to the connection sheet 15 respectively.

Cells are core components for electrochemical reactions in the secondary battery. The first cell 21 and the second cell 22 are respectively formed by winding or stacking a positive electrode plate and a negative electrode plate, and a separator is arranged between the positive electrode plate and the negative electrode plate. During charging and discharging of the secondary battery, the positive electrode plate and the negative electrode plate can undergo corresponding chemical reactions, and are connected to external device components through the first tab 211 and the second tab 221 to form a current loop. In an embodiment, the first tab 211 and the second tab 221 are respectively connected to the electrode terminal 13 through the connection sheet 15. The connection sheet 15 provided in the present disclosure has a connection portion. The connection portion is located on two sides of the protruding portion 151 respectively. The connection portion is configured to be connected to the first tab 211 and the second tab 221. Part of the first tab 211 and the second tab 221 may fit a bottom wall or a side wall of the accommodating portion 152, so as to make full use of the space inside the shell.

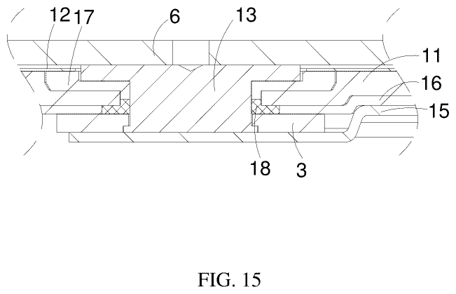

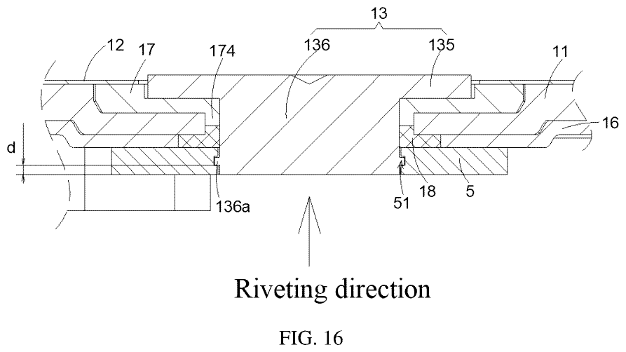

As shown in FIG. 15 and FIG. 16, some embodiments of the present disclosure provide a battery pack 3. The battery pack 3 includes a plurality of secondary batteries. The secondary batteries are the secondary batteries described in any one of the above embodiments.

The battery pack 3 includes a box body, a plurality of secondary batteries, and a housing. The secondary batteries are arranged inside the housing. The box is configured to provide an accommodating space for the secondary battery, and can have effects of protection and isolation. The plurality of secondary batteries are electrically connected to each other to form a module, so that the battery pack 3 has a higher voltage and a larger battery capacity.

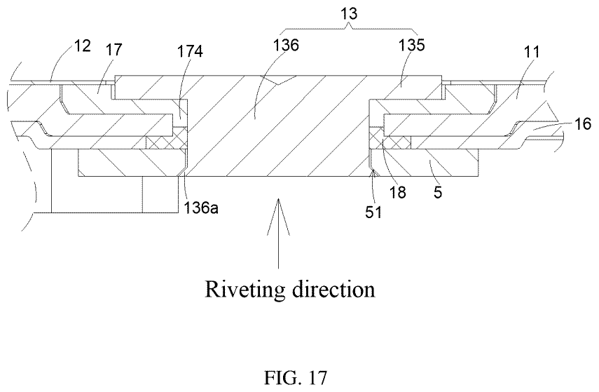

As shown in FIG. 17, some embodiments of the present disclosure provide an energy storage box 4. The energy storage box 4 includes a box body, an inverter, a BMS, and a battery pack 3. The battery pack 3 is the battery pack 3 described in any one of the above embodiments. The plurality of secondary batteries in the battery pack 3 may be connected in series, or connected in parallel, or connected in series and in parallel. The secondary batteries are connected to each other to form one or more modules and are arranged in the box body. Other components, such as a busbar and a connecting component, may be arranged inside the box body to realize electrical connections between the secondary batteries.

The energy storage box 4 is a device configured to store energy. The energy storage box 4 includes parts such as a battery system, a monitoring system, a battery management unit, and a fire fighting system. The monitoring system mainly implements external communication connections, network data collection and monitoring, and data analysis and processing to ensure accurate and reliable data monitoring, accurate voltage and current sampling, and the like. The battery management unit has high-precision single voltage detection and current detection functions to ensure voltage balance of battery modules and prevent an influence of circulating currents between the battery modules on system operation efficiency, so that the device can operate normally and stably.

The energy storage box 4 is provided with firefighting and air conditioning systems to ensure operational safety. The firefighting system senses environmental changes inside the energy storage box 4 through safety devices such as a smoke sensor, a temperature sensor, and a humidity sensor, detects faults and fire conditions, and can automatically extinguish a fire after the fire occurs. The air conditioning system can control an air conditioning cooling and heating system through a thermal management device according to an external environment temperature and an internal environment temperature, so that a temperature inside the energy storage box 4 can be maintained within an appropriate range, ensuring a safe operating environment for the battery and prolonging a service life of the battery.

The energy storage box 4 is finally integrated and mounted inside the box body by connecting a plurality of battery packs 3 to each other. The inverter is an apparatus that converts DC power into AC power. During operation, the inverter acquires DC power from the battery pack 3 or other sources, converts the DC power into appropriate AC power by regulation and control, and inputs the AC power obtained by conversion into a power grid to supply a load. The BMS is a device that monitors a state of an energy storage battery, and is mainly intended to intelligently manage and maintain each battery unit, prevent overcharging and over-discharging of the battery, prolong the service life of the battery, and monitor the state of the battery. The BMS is one core subsystem of a battery energy storage system, which is mainly responsible for monitoring operating states of batteries in a battery energy storage unit and ensuring safe and reliable operation of the energy storage unit. The BMS can monitor and collect state parameters of the energy storage battery in real time, analyze and calculate relevant state parameters, obtain more system parameters to evaluate the state, and realize management and control over a battery body according to a specific protection control strategy, to ensure safe and reliable operation of the entire battery energy storage unit. At the same time, the BMS may connect to and interact with other external devices through its own communication interface and input interface to form linkage control over respective subsystems in an entire energy storage apparatus, to ensure safe and efficient operation of the energy storage box 4.

The present disclosure provides a secondary battery, a battery pack 3, and an energy storage box 4. The secondary battery includes an end cover assembly 1. The end cover assembly 1 includes a top cover 11, a top patch 12, and an electrode terminal 13. The top cover 11 has a first recessed portion 111. The first recessed portion 111 is recessed in a height direction of the secondary battery. A bottom wall of the first recessed portion 111 has a first mounting hole 112. The top patch 12 is connected to the top cover 11. The electrode terminal 13 includes a main body 131 and a flange 132. The flange 132 is arranged along a circumferential direction of the main body 131. The flange 132 is mounted in the first recessed portion 111. A protruding height of the main body 31 relative to the top patch 12 is smaller. Moreover, the secondary battery further includes a first fixing member 14, a second fixing member 17, and a connection sheet 15. The second fixing member 17 is made of an insulating material, sleeves the electrode terminal 13, and abuts against the flange 132. The first fixing member 14 sleeves the second fixing member 17 and is welded to the top cover 11. The connection sheet 15 is located on a side of the top cover 11 away from the electrode terminal 13. The connection sheet 15 has a protruding portion 151. The protruding portion 151 protrudes in a direction close to the electrode terminal 13. The protruding portion 151 passes through the first mounting hole 112 and is connected to the electrode terminal 13. The end cover assembly 1 provided in the embodiments of the present disclosure has a compact structure and a smaller thickness, which helps increase a capacity and energy density of the secondary battery.

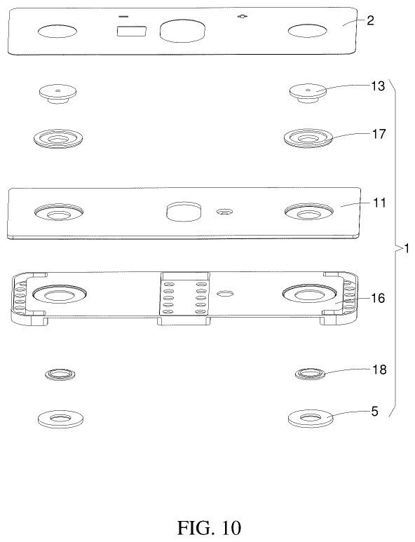

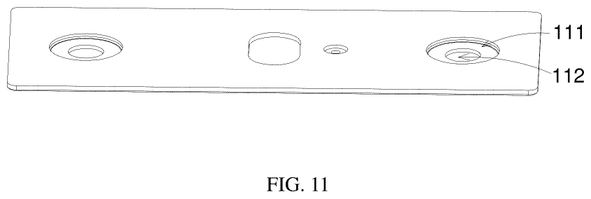

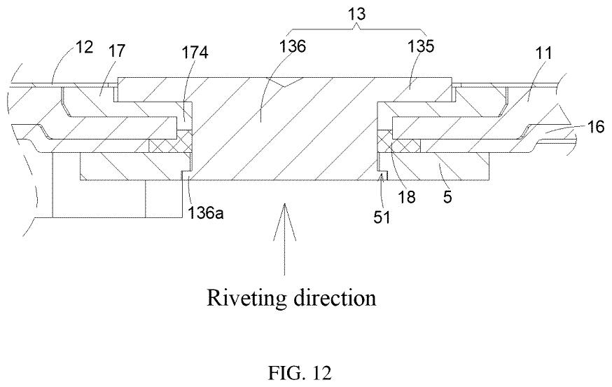

As shown in FIG. 10, some embodiments of the present disclosure provide a secondary battery. The secondary battery includes an end cover assembly 1 and a top patch 2. The end cover assembly 1 includes a top cover 11 and an electrode terminal 13. The electrode terminal 13 is mounted on the top cover 11. The electrode terminal 13 may be riveted to the top cover 11 through a third fixing member 5. Riveting has advantages of higher connection strength, a higher load-bearing capability, and better corrosion resistance, has lower costs, and is suitable for larger-scale production. The top patch 2 is located on a side of the end cover assembly 1 away from interior of the secondary battery to protect a structure of the secondary battery, to reduce an influence of environmental factors on the secondary battery. The top cover 11 is provided with at least one first recessed portion 111. As shown in FIG. 11, the top cover 11 is provided with at least one first recessed portion 111. A number of the first recessed portion 111 may be set according to a number of the electrode terminal 13. Generally, the secondary battery includes a positive electrode terminal 13 and a negative electrode terminal 13. The top cover 11 is provided with two first recessed portions 111. The positive electrode terminal 13 and the negative electrode terminal 13 fit the corresponding first recessed portions 111 respectively. The first recessed portion 111 is recessed towards a side close to the interior of the secondary battery. A bottom wall of the first recessed portion 111 is provided with the first mounting hole 112. The electrode terminal 13 extends into the first recessed portion 111 and partially passes through the first mounting hole 112, so that the electrode terminal 13 sleeves the first mounting hole 112. As shown in FIG. 12, a sealing member 18 is arranged along a circumferential direction of the electrode terminal 13. The third fixing member 5 is arranged on a side of the top cover 11 away from the top patch 2 and sleeves the electrode terminal 13. Along a thickness direction of the end cover assembly 1, an upper surface of the electrode terminal 13 is higher than an upper surface of the top patch 2, and a distance between the upper surface of the electrode terminal 13 and the upper surface of the top patch 2 is no more than 2 mm. The upper surface of the electrode terminal 13 is a surface on a side of the electrode terminal 13 away from the interior of the secondary battery, and is generally connected to a busbar 5. The upper surface of the top patch 2 is a surface on a side of the top patch 2 away from the interior of the secondary battery. The electrode terminal 13 protrudes from the top patch 2, and a protruding distance is a, where 0<a≤2 mm. The third fixing member 5 may be a riveting member. The electrode terminal 13 is mounted on the top cover 11 by riveting. The end cover assembly 1 further includes a second fixing member 17. The second fixing member 17 sleeves the electrode terminal 13, is located on a side of the electrode terminal 13 facing the top patch 2, and extends into the first recessed portion 111. The second fixing member 17 includes an extending portion 174. The extending portion 174 extends along a thickness direction of the end cover assembly 1 and is arranged along the circumferential direction of the electrode terminal 13. At least part of the extending portion 174 extends into the first mounting hole 112 and is located between the electrode terminal 13 and a hole wall of the first mounting hole 112. The third fixing member 5 may be made of a material such as metal or ceramic. The second fixing member 17 is made of an insulating material.

A protruding dimension of the upper surface of the electrode terminal 13 relative to the upper surface of the top patch 2 may be 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or the like.

Compared with the arrangement of the third fixing member 5 on one side of the top cover 11 away from the interior of the secondary battery, according to the solution provided in the embodiments of the present disclosure, the third fixing member 5 is fixed to one side of the top cover 11 facing the interior of the secondary battery, which can reduce a space on an outer side of the top cover 11 occupied by the third fixing member 5. Since the third fixing member 5 is located on an inner side of the top cover 11, a protruding dimension of the electrode terminal 13 on the outer side of the top cover 11 can be reduced, thereby helping reduce a dimension of the end cover assembly 1 in the thickness direction. The electrode terminal 13 is located in the first recessed portion 111, which can further reduce the protruding dimension of the electrode terminal 13 relative to the top cover 11, so that an overall structure of the end cover assembly 1 is more compact, and the space occupied by the end cover assembly 1 can be reduced. Along the thickness direction of the end cover assembly 1, part of the electrode terminal 13 overlaps with the top cover 11, and there is no need to calculate repeated parts when the thickness of the top cover 11 is calculated. When an overall dimension of the secondary battery is fixed, the end cover assembly 1 occupies a smaller dimension, and a region of the secondary battery configured to accommodate the electrolyte and the electrode plates has a larger dimension, which helps increase the capacity and the energy density of the secondary battery and is more in line with an actual usage requirement.

The electrode terminal 13 may serve as a rivet. During the riveting, the electrode terminal 13, the top cover 11, the sealing member 18, and the third fixing member 5 are sequentially placed, and the riveting is performed from one side where the third fixing member 5 is located, that is, a side of the end cover assembly 1 facing the interior of the secondary battery. Through such a design, a number of the parts can be reduced, difficulty of machining can be reduced, and the structure of the end cover assembly 1 can be more compact.

The second fixing member 17 may be an insulating member to reduce a possibility of a short circuit in the secondary battery caused by an additional electrical connection between the electrode terminal 13 and the top cover 11 and/or additional components, thereby improving safety of the secondary battery. The extending portion 174 extends into the first mounting hole 112, which can further improve an insulation effect of the second fixing member 17 and reduce a possibility of electrical connections between the electrode terminal 13 and other components. At the same time, the extending portion 174 may also serve as a filling material between the electrode terminal 13 and the hole wall of the first mounting hole 112 to reduce a possibility of shaking of the electrode terminal 13 relative to the top cover 11, thereby improving stability of the connection between the electrode terminal 13 and the top cover 11 and being more in line with an actual usage requirement.

In some embodiments, along the thickness direction of the end cover assembly 1, the upper surface of the electrode terminal 13 is higher than an upper surface of the top cover 11, and the upper surface of the top cover 11 is a surface on a side of the top cover 11 facing the top patch 2. That is, the electrode terminal 13 protrudes from the top cover 11. Moreover, a protruding distance of the electrode terminal 13 relative to the top cover 11 is no more than 3 mm. A dimension of the electrode terminal 13 protruding from the top cover 11 may be 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, or the like.

Through such a design, the end cover assembly 1 can be more compact in structure, thereby helping reduce the space occupied by the end cover assembly 1.

The thickness of the end cover assembly 1 is m, a height of the part of the secondary battery configured to accommodate the electrolyte and the electrode plates is n, and the height of the secondary battery is h. It may be generally considered that m+n=h. A height dimension of the secondary battery is relatively fixed. In a case where h is fixed, when m is smaller, n is larger. In the solution provided in the embodiments of the present disclosure, the third fixing member 5 is arranged on the side of the top cover 11 facing the interior of the secondary battery, and the top cover 11 is provided with a first recessed portion 111 configured to accommodate the electrode terminal 13, so that the structure of the end cover assembly 1 can be more compact and the dimension of the end cover assembly 1 in the thickness direction can be reduced. That is, m can be reduced. When m decreases, n increases while h remains unchanged. That is, the space of the part of the battery configured to accommodate the electrolyte and the electrode plates becomes larger. Therefore, the battery can more electrolyte and/or larger-sized electrode plates, thereby increasing the capacity of the secondary battery by 2% to 3% in a case where a total volume of the secondary battery remains unchanged, which increases the energy density of the secondary battery and is more in line with an actual usage requirement.

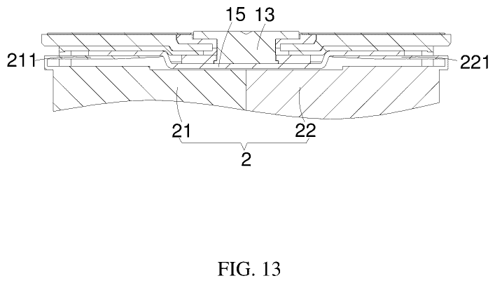

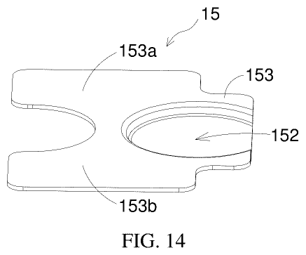

As shown in FIG. 13, in some embodiments, the secondary battery further includes a connection sheet 15 and a cell assembly 2, the connection sheet 15 is configured to be connected to the cell assembly 2 and the electrode terminal 13, and the cell assembly 2 includes at least one bare cell. The bare cell includes a positive electrode plate, a negative electrode plate, and an isolation film, which are machined by winding, stacking, or the like. The cell assembly 2 includes a tab. The tab may be connected to the connection sheet 15 by welding or the like. As shown in FIG. 14, the connection sheet 15 has an accommodating portion 152, and the accommodating portion 152 is arranged on a side of the connection sheet 15 facing the electrode terminal 13 and is recessed in a direction away from the end cover assembly 1. Along the thickness direction of the end cover assembly 1, as shown in FIG. 15, the electrode terminal 13 extends into the accommodating portion 152 and is connected to an inner wall of the accommodating portion 152, so that the electrode terminal 13 can be electrically connected to the tab through the connection sheet 15.

Through the arrangement of the accommodating portion 152 in the connection sheet 15, accuracy of the connection between the connection sheet 15 and the electrode terminal 13 can be improved. At the same time, the accommodating portion 152 is recessed towards one side inside the secondary battery, the electrode terminal 13 can extend more into the interior of the secondary battery, and when the height of the secondary battery is calculated, an overlapping portion between the electrode terminal 13 and the connection sheet 15 in the height direction may not be incorporated in the total height. Therefore, the secondary battery is more compact in structure, thereby helping increase the energy density of the secondary battery.

As shown in FIG. 13, in some embodiments, the cell assembly 2 includes a first cell 21 and a second cell 22, the first cell 21 includes a first tab 211, and the second cell 22 includes a second tab 221. As shown in FIG. 14, the connection sheet 15 includes an electrode terminal connection portion 153, a first tab connection portion 153a, and a second tab connection portion 33, the first tab connection portion 153a is electrically connected to the first tab 211, the second tab connection portion 33 is electrically connected to the second tab 221, and the electrode terminal connection portion 153 is electrically connected to the electrode terminal 13. Along a width direction of the end cover assembly 1, the first tab connection portion 153a and the second tab connection portion 33 are located on two opposite sides of the electrode terminal connection portion 153, the accommodating portion 152 is arranged on a side of the electrode terminal connection portion 153 facing the electrode terminal 13, and a side of the electrode terminal connection portion 153 facing the cell assembly protrudes at a position corresponding to the accommodating portion 152.

The first tab 211 may include a first positive tab and a first negative tab. The second tab 221 may include a second positive tab and a second negative tab. The first positive tab and the second positive tab are connected to a same connection sheet 15. The first negative tab and the second negative tab are connected to a same connection sheet 15. The secondary battery may include two connection sheets 15 which are respectively configured to be connected to a positive tab and a negative tab of the cell assembly 2. The electrode terminal 13 electrically connected to the positive tab is the positive electrode terminal 13, and the electrode terminal 13 electrically connected to the negative tab is the negative electrode terminal 13.

Through such a design, the electrode terminal 13 can be sunk by using a space between the tab connection portions. Through the sinking of the electrode terminal 13, the protruding dimension of the electrode terminal 13 relative to the top cover 11 and the top patch 2 can be reduced, space utilization can be improved, and the overall structure of the secondary battery can be more compact, thereby helping increase the energy density of the secondary battery. Moreover, the tab connection portions are located on two opposite sides of the electrode terminal connection portion 153, which can reduce a possibility of interference with the tab when the electrode terminal 13 is sunk and can reduce an influence of the sinking of the electrode terminal 13 on the connection between the tab and the connection sheet 15.

In some embodiments, along the thickness direction of the end cover assembly 1, a depth of the accommodating portion 152 ranges from 3 mm to 6 mm. The thickness direction of the end cover assembly is the thickness direction of the connection sheet 15, and is also the height direction of the secondary battery. The depth of the accommodating portion 152 may be 1.0 mm, 1.5 mm, 2.0 mm, 2.5 mm, 3.0 mm, 3.5 mm, 4.0 mm, 4.5 mm, 5.0 mm, 5.5 mm, 6.0 mm, or the like.

The depth of the accommodating portion 152 may be set differently according to the dimension of the electrode terminal 13 and a structural requirement of the secondary battery. If the depth of the accommodating portion 152 is larger, the electrode terminal 13 has a longer sinking distance and a smaller protruding dimension relative to the top cover 11 and the top patch 2. When the depth of the accommodating portion 152 is less than 1 mm, due to the smaller depth of the accommodating portion 152, a space for the sinking of the electrode terminal 13 is relatively small, and an influence on the thickness dimension of the end cover assembly 1 is relatively small. When the depth of the accommodating portion 152 is greater than 6 mm, due to the larger depth of the accommodating portion 152, the electrode terminal 13 has a large sinking distance and is prone to interference with the internal structure of the secondary battery, affecting arrangement spaces of the structures such as the tab, the electrolyte, and the electrode plate. Therefore, the depth of the accommodating portion 152 may be set to a value in a range of 1 mm to 6 mm.

In the solution provided in the embodiments of the present disclosure, through the design of the internal structure of the secondary battery, a space between the tabs of the bare cell is used to cooperate with the accommodating portion 152 of the connection sheet 15 so that the electrode terminal 13 can be sunk, thereby making the overall structure of the end cover assembly 1 more compact and reducing a dimension occupied by the end cover assembly 1 in the height direction. Since the protruding dimension of the electrode terminal 13 relative to the top patch 2 is reduced, in a case where the position of the upper surface of the electrode terminal 13 in the height direction of the secondary battery remains unchanged, compared with the secondary battery in the related art, the overall position of the top patch 2 and other components of the end cover assembly 1 is relatively upward, leaving more space for other components of the secondary battery, so that the secondary battery can accommodate larger-sized electrode plates and more electrolyte. Therefore, according to the solution provided in the embodiments of the present disclosure, the capacity of the secondary battery can be increased without increasing an overall external dimension of the secondary battery, thereby increasing the energy density of the secondary battery and being more in line with an actual usage requirement.

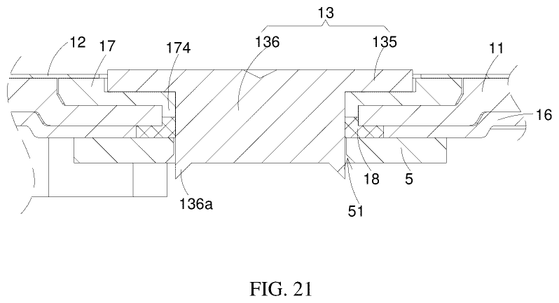

As shown in FIG. 21, in some embodiments, the electrode terminal 13 includes a limiting section 135 and a riveting section 136 connected to each other, and a cross-sectional area of the limiting section 135 is greater than a cross-sectional area of the riveting section 136. The electrode terminal 13 may be a cylindrical electrode terminal 13, a square electrode terminal 13, or the like. Taking the cylindrical electrode terminal 13 as an example, both the limiting section 135 and the riveting section 136 are cylindrical steps, and a radial dimension of the limiting section 135 is greater than a radial dimension of the riveting section 136. The limiting section 135 is located at an end of the electrode terminal 13 away from the interior of the secondary battery, a portion of the riveting section 136 passes through the first mounting hole 112, and the third fixing member 5 sleeves the portion of the riveting section 136 passing through the first mounting hole 112.

A cross section of the electrode terminal 13 may approximately have a T-shaped structure. The limiting section 135 is configured to limit a relative position of the electrode terminal 13 and the top cover 11. The riveting section 136 is configured for riveting deformation. During the riveting, an end of the riveting section 136 away from the limiting section 135 is riveted. The riveting section 136 may be deformed into a limiting portion 136a by stamping or the like, so that the electrode terminal 13 changes from the T-shaped structure to an approximately I-shaped structure. Components such as the top cover 11 and the sealing ring are clamped by the limiting portion 136a, so that the electrode terminal 13, the top cover 11, and the sealing ring can form an entirety. When the secondary battery is assembled, the end cover assembly 1 can be machined in advance, and then the machined end cover assembly 1 is wholly mounted on the secondary battery. Through such a design, the end cover assembly 1 can be modularized, which has higher production efficiency and is more in line with an actual requirement.

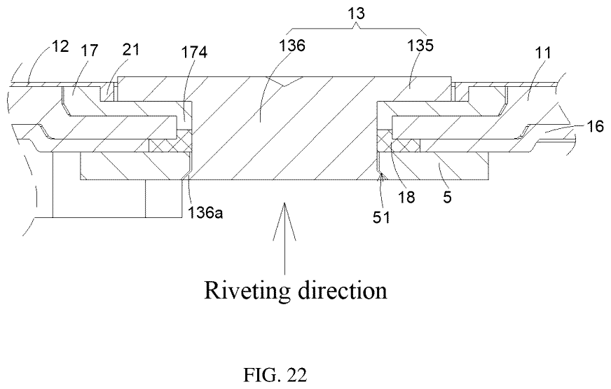

As shown in FIG. 22, in some embodiments, a side of the third fixing member 5 away from the top cover 11 has an accommodating groove 51, a side of the riveting section 136 away from the limiting section 135 is provided with a limiting portion 136a, and the limiting portion 136a is arranged along a circumferential direction of the riveting section 136 and protrudes relative to the riveting section 136. The accommodating groove 51 is configured to accommodate the limiting portion 136a.

In the riveting, the components such as the electrode terminal 13 are placed well, the side of the third fixing member 5 having the accommodating groove 51 is arranged away from the top cover 11, the riveting section 136 is riveted so that the riveting section 136 is deformed into the limiting portion 136a, and the limiting portion 136a extends into the accommodating groove 51.

The third fixing member 5 is provided with the accommodating groove 51 to accommodate the limiting portion 136a, and when the thickness of the end cover assembly 1 is calculated, there is no need to calculate a portion of the limiting portion 136a in the accommodating groove 51.

In some embodiments, the limiting portion 136a may be completely located in the accommodating groove 51.

Through such a design, an overall thickness dimension of the end cover assembly 1 can be further reduced, thereby reducing a space occupied by the end cover assembly 1, which helps increase the capacity and the energy density of the secondary battery and is more in line with an actual usage requirement.

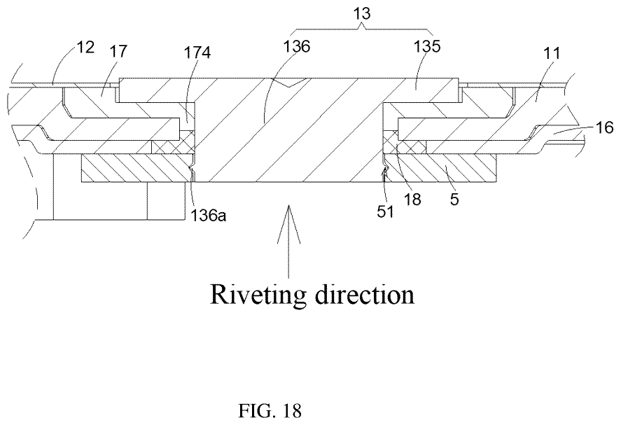

As shown in FIG. 12, FIG. 16, FIG. 17, and FIG. 18, in some embodiments, a distance between the limiting portion 136a and an end face on the side of the riveting section 136 away from the limiting section 135 is d, where 0≤d≤3 mm. The limiting portion 136a fits a side wall of the accommodating groove 51. That is, a protruding shape of the limiting portion 136a matches a recessed shape of the accommodating groove 51. The distance between the limiting portion 136a and the end face on the side of the riveting section 136 away from the limiting section 135 may be 0 mm, 0.5 mm, 1.0 mm, 1.5 mm, 2.0 mm, 2.5 mm, 3.0 mm, or the like.

A formation position and a structure of the limiting portion 136a may be machined according to a requirement. A cross section of the limiting portion 136a may be in a shape of a triangle, a rectangle, or the like. The limiting portion 136a having different structures may be machined and formed according to requirements, and the accommodating groove 51 matching therewith may be provided.

As shown in FIG. 18, in some embodiments, along the height direction of the secondary battery, the sealing member 18 abuts against the extending portion 174.

Through such a design, the coating of the electrode terminal 13 with the second fixing member 17 and the sealing member 18 can be improved, and a possibility of a gap between the second fixing member 17 and the sealing member 18 can be reduced, so that sealing performance of the end cover assembly 1 can be improved, which reduces a possibility of a short circuit in the electrode terminal 13 caused by entry of foreign matter into the end cover assembly 1, helps improve safety and operational stability of the secondary battery, and is more in line with an actual usage requirement.

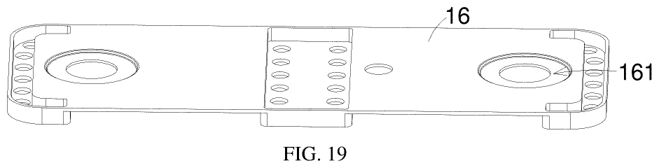

As shown in FIG. 19, in some embodiments, the end cover assembly 1 includes a lower plastic member 16, and the lower plastic member 16 is located on a side of the top cover 11 facing the interior of the secondary battery and sleeves the electrode terminal 13. The lower plastic member 16 has a second recessed portion 161, the second recessed portion 161 is arranged corresponding to the first recessed portion 111, and the second recessed portion 161 is recessed in a direction away from the top cover 11 to accommodate the first recessed portion 111. The lower plastic member 16 sleeves the electrode terminal 13 through the second recessed portion 161, and the sealing member 18 is arranged along the circumferential direction of the electrode terminal 13 and is located between the electrode terminal 13 and a side wall of the second recessed portion 161.

The lower plastic member 16 is configured to reduce a possibility of a short circuit between the tab and the top cover 11, to improve sealing performance and safety of the secondary battery. The lower plastic member 16 is provided with the second recessed portion 161 recessed towards the interior of the secondary battery can avoid and accommodate the first recessed portion 111, thereby reducing a possibility of interference with other components due to the arrangement of the first recessed portion 111 in the top cover 11. A body portion of the sealing member 18 may be located in the second recessed portion 161 to have effects of sealing and insulation together with the lower plastic member 16. Moreover, the sealing member 18 may be further configured to fill a gap between the electrode terminal 13 and the second recessed portion 161, which has an effect of sealing and can also reduce accuracy of fit between the electrode terminal 13 and the lower plastic member 16.

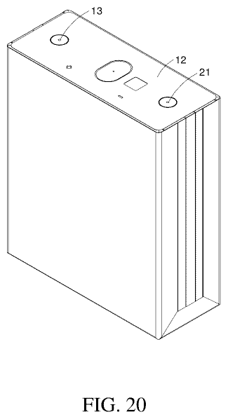

The overall structure of the secondary battery is shown in FIG. 20. An outer side of the shell of the secondary battery may be coated with a blue film or the like.

In some embodiments, the top patch 2 sleeves the electrode terminal 13 through a connection hole, and a distance between a hole wall of the connection hole and the electrode terminal 13 ranges from 0.5 mm to 3 mm.

The distance between the hole wall and the electrode terminal 13 may be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, or the like.

The top patch 2 may be further provided with a structure such as a blasting hole opening. The top cover 11 may be provided with a QR code used to identify information of the secondary battery. The top patch 2 is also provided, at a corresponding position, with an opening used to display the QR code. Also, the top patch 2 may be further provided with a fool-proof mark used to mark whether the electrode terminal 13 is positive or negative.

The limiting portion 136a of the electrode terminal 13 may be formed after the riveting. That is, prior to the riveting, an end of the electrode terminal 13 facing the interior of the secondary battery is planar. Alternatively, as shown in FIG. 21, the end of the electrode terminal 13 facing the interior of the secondary battery is provided with a limiting portion 136a protruding along the height direction of the secondary battery. During the riveting, the limiting portion 136a deforms so that the limiting portion 136a extends along a radial direction of the electrode terminal 13 and is located in the accommodating groove 51 of the third fixing member 5.

As shown in FIG. 22, in some embodiments, along the radial direction of the electrode terminal 13, there is a gap between the second fixing member 17 and the electrode terminal 13, and the top patch 2 has a bending portion 123. The bending portion 123 may bend towards one side close to the top cover 11 and extend into the gap between the second fixing member 17 and the electrode terminal 13. Through such a design, an area of contact between the top patch 2 and the end cover assembly 1 can be increased. At the same time, the bending portion 123 may be in the circumferential direction of the electrode terminal 13, so as to protect the circumferential direction of the electrode terminal 13, which reduces a possibility of a short circuit in the electrode terminal 13 caused by entry of foreign matter and helps improve safety of the secondary battery.

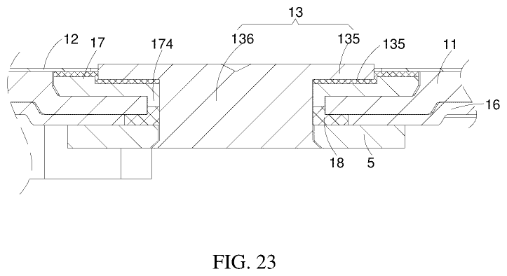

As shown in FIG. 23, in some embodiments, the secondary battery further includes a thermally conductive member 121. The thermally conductive member 121 may be circumferentially arranged around the electrode terminal 13, which may, for example, sleeve the electrode terminal 13. In use of the secondary battery, the electrode terminal 13 is prone to heat generation, and through the arrangement of the thermally conductive member 121 around the electrode terminal 13, heat generated by the electrode terminal 13 can be directed in a direction away from the electrode terminal 13 in time, thereby reducing a possibility of a rise in a local temperature of the secondary battery caused by accumulation of the heat around the electrode terminal 13.

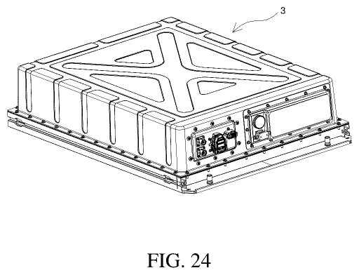

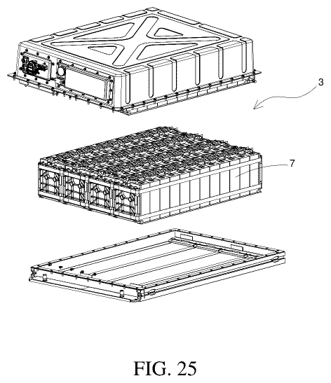

Based on the secondary batteries described in the above embodiments, as shown in FIG. 24 and FIG. 25, some embodiments of the present disclosure further provide a battery pack 3. The battery pack 3 includes at least one battery module 7. The battery module 7 includes at least one secondary battery described in any one of the above embodiments. When the battery module 7 includes a plurality of secondary batteries, the secondary batteries may be electrically connected through a busbar 5. The busbar 5 may be electrically connected to the electrode terminal 13 of the secondary battery by welding or the like. Since the secondary battery achieves the above technical effects, the battery pack 3 including the secondary battery also achieves the corresponding technical effects, which are not described in detail herein.

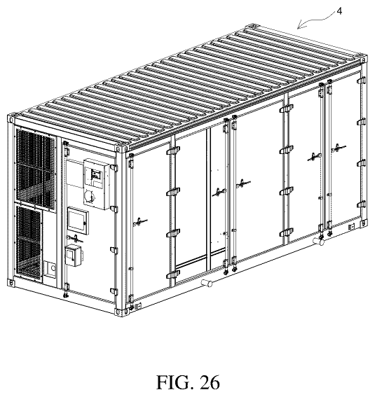

As shown in FIG. 26, some embodiments of the present disclosure provide an energy storage box 4. The energy storage box 4 includes an inverter, a BWS, and at least one battery pack 3. The inverter is configured to convert DC power into AC power. At the same time, the inverter has advantages of higher conversion efficiency, faster startup, higher safety, and can also have functions such as short circuit, overload, overvoltage/undervoltage, and over-temperature protection. The BWS is configured to make the battery pack 3 operate within a safe operating interval, and may control charging and discharging power of the battery pack according to factors such as an ambient temperature, a battery state, and an electricity demand, to enhance safety of the battery pack 3 and make an operating state of the battery pack 3 more reasonable, thereby helping prolong a battery life and a service life of the battery pack 3.

Some embodiments of the present disclosure provide a secondary battery, a battery pack, and an energy storage box. The secondary battery includes an end cover assembly 1 and a top patch 2. The end cover assembly 1 includes a top cover 11 and an electrode terminal 13. The electrode terminal 13 is mounted on the top cover 11. The electrode terminal 13 may be riveted to the top cover 11 through a third fixing member 5. The top patch 2 is located on a side of the end cover assembly 1 away from interior of the secondary battery. The top cover 11 is provided with at least one first recessed portion 111 with a first mounting hole 112 in a bottom wall. The electrode terminal 13 sleeves the first mounting hole 112. A sealing member 18 is arranged along a circumferential direction of the electrode terminal 13. The third fixing member 5 is arranged on a side of the top cover 11 away from the top patch 2, and sleeves the electrode terminal 13. A protruding dimension of the electrode terminal 13 from the top patch 2 is within 2 mm. A second fixing member 17 sleeves a side of the electrode terminal 13 facing the top patch 2. An extending portion 174 of the second fixing member 17 extends along a thickness direction of the end cover assembly 1 and is arranged along the circumferential direction of the electrode terminal 13. At least part of the extending portion 174 extends into the first mounting hole 112 and is located between the electrode terminal 13 and a hole wall of the first mounting hole 112. The second fixing member 17 is made of an insulating material. Through such a design, the end cover assembly 1 can be more compact in structure, which reduces a space occupied by the end cover assembly 1, thereby helping increase a capacity and energy density of the secondary battery.

The structure, features, and effects of the present disclosure are described in detail above according to the embodiments shown in the drawings. The above are only preferred embodiments of the present disclosure, but the present disclosure does not limit the scope of implementation as illustrated in the drawings. Any changes made in accordance with the conception of the present disclosure, or equivalent embodiments modified as equivalent changes, which still do not exceed the spirit covered by the specification and the drawings, shall fall within the protection scope of the present disclosure.

What is claimed is:

1. A secondary battery, comprising an end cover assembly, wherein the end cover assembly comprises:
a top cover comprising a first recessed portion, wherein the first recessed portion is recessed along a height direction of the secondary battery, and a bottom wall of the first recessed portion is provided with a first mounting hole;
a top patch connected to the top cover and located on a side of the end cover assembly away from interior of the secondary battery;
an electrode terminal, wherein at least part of the electrode terminal is sleeved in the first mounting hole, and a protruding height of an upper surface of the electrode terminal relative to the top patch is H1, where 0<H1≤2 mm;
a second fixing member that sleeves on the electrode terminal, wherein the second fixing member is made of an insulating material;
a connection sheet, located on a side of the top cover away from the electrode terminal, and connected to the electrode terminal; and
a sealing member, arranged along a circumferential direction of the electrode terminal;
wherein the end cover assembly further comprises a first fixing member, the first fixing member sleeves on the second fixing member and is welded to the top cover to limit the electrode terminal, the electrode terminal and the first fixing member are located on two sides of the second fixing member respectively, the electrode terminal comprises a main body and a flange, the flange is arranged along a circumferential direction of the main body, the second fixing member abuts against the flange, the connection sheet comprises a protruding portion, the protruding portion protrudes towards the electrode terminal and passes through the first mounting hole to be connected to the electrode terminal, or the electrode terminal is mounted to the top cover through a third fixing member, the third fixing member is located on a side of the top cover away from the top patch and sleeves on the electrode terminal, the second fixing member is arranged on a side of the top cover facing the top patch and extends into the first recessed portion, the second fixing member comprises an extending portion, the extending portion extends along a thickness direction of the end cover assembly and is arranged along the circumferential direction of the electrode terminal, and at least part of the extending portion extends into the first mounting hole and is located between the electrode terminal and a hole wall of the first mounting hole.

2. The secondary battery according to claim 1, wherein a protruding height of the electrode terminal relative to the top cover is H2, where 0.5 mm≤H2≤4 mm.

3. The secondary battery according to claim 1, wherein
the end cover assembly further comprises a lower plastic member that is located between the top cover and the third fixing member and sleeves on the electrode terminal;
the lower plastic member is provided with a second recessed portion recessed towards a direction away from the top cover to accommodate the first recessed portion; and
the lower plastic member sleeves on the electrode terminal through the second recessed portion, and the sealing member is arranged along the circumferential direction of the electrode terminal and is located between the electrode terminal and a side wall of the second recessed portion.

4. The secondary battery according to claim 3, wherein a bottom wall of the second recessed portion comprises a second mounting hole, and the first mounting hole is in communication with the second mounting hole.

5. The secondary battery according to claim 4, wherein
the connection sheet comprises an accommodating portion arranged along a circumferential direction of the protruding portion, and recessed towards a direction away from the electrode terminal, and
the second recessed portion abuts against the accommodating portion.

6. The secondary battery according to claim 1, wherein a side wall of the second fixing member comprises an avoidance groove, and at least part of the first fixing member is located in the avoidance groove.

7. The secondary battery according to claim 1, wherein
the second fixing member comprises a supporting portion extending along the height direction of the secondary battery, the supporting portion abuts against the first recessed portion, and the flange is located on an inner side of the supporting portion.

8. The secondary battery according to claim 1, wherein the sealing member is located between the electrode terminal and the first recessed portion.

9. The secondary battery according to claim 1, wherein
an inner wall of the second fixing member comprises a first limiting surface, a side wall of the main body comprises a second limiting surface, and
the first limiting surface abuts against the second limiting surface.

10. The secondary battery according to claim 1, wherein
along the thickness direction of the end cover assembly, an upper surface of the electrode terminal is higher than an upper surface of the top cover, and a distance between the upper surface of the electrode terminal and the upper surface of the top cover is no more than 3 mm.

11. The secondary battery according to claim 1, further comprising a connection sheet and a cell assembly, wherein the cell assembly comprises a tab, and the electrode terminal is electrically connected to the tab through the connection sheet; and
the connection sheet is provided with an accommodating portion, the accommodating portion is recessed towards a direction away from the end cover assembly, and the electrode terminal extends into the accommodating portion along the thickness direction of the end cover assembly and is connected to an inner wall of the accommodating portion.

12. The secondary battery according to claim 11, wherein
the cell assembly comprises a first cell and a second cell, the first cell comprises a first tab, the second cell comprises a second tab, and the connection sheet comprises an electrode terminal connection portion, a first tab connection portion, and a second tab connection portion; the first tab connection portion is electrically connected to the first tab, and the second tab connection portion is electrically connected to the second tab; and
along a width direction of the end cover assembly, the first tab connection portion and the second tab connection portion are located on two opposite sides of the electrode terminal connection portion, the accommodating portion is arranged on a side of the electrode terminal connection portion facing the electrode terminal, and a side of the electrode terminal connection portion facing the cell assembly protrudes at a position corresponding to the accommodating portion.

13. The secondary battery according to claim 12, wherein along the thickness direction of the end cover assembly, a depth of the accommodating portion ranges from 3 mm to 6 mm.

14. The secondary battery according to claim 1, wherein
the electrode terminal comprises a limiting section and a riveting section connected to each other,
a cross-sectional area of the limiting section is greater than a cross-sectional area of the riveting section, the limiting section is located at an end of the electrode terminal away from the interior of the secondary battery, the cross-sectional area of the limiting section is greater than a cross-sectional area of the first mounting hole, and
part of the riveting section passes through the first mounting hole and sleeved in the third fixing member.

15. The secondary battery according to claim 14, wherein
a side of the third fixing member away from the top cover is provided with an accommodating groove, and a side of the riveting section away from the limiting section is provided with a limiting portion,
wherein the limiting portion is arranged along a circumferential direction of the riveting section and protrudes relative to the riveting section, and the accommodating groove is configured to accommodate the limiting portion.

16. The secondary battery according to claim 15, wherein a distance between the limiting portion and an end face on the side of the riveting section away from the limiting section is d, where 0≤d≤3 mm; and
the limiting portion fits a side wall of the accommodating groove.

17. The secondary battery according to claim 1, wherein along the height direction of the secondary battery, the sealing member abuts against the extending portion.

18. The secondary battery according to claim 1, wherein
the top patch comprises an opening with a turnup formed at an edge of the opening, the turnup extends along the height direction of the secondary battery, the turnup is arranged around the electrode terminal, and the turnup is capable of covering part of a side wall of the electrode terminal.

19. A battery pack, wherein the battery pack comprises at least one battery module, and the battery module comprises at least one secondary battery;
wherein the secondary battery comprises an end cover assembly, and the end cover assembly comprises:
a top cover comprising a first recessed portion, wherein the first recessed portion is recessed along a height direction of the secondary battery, and a bottom wall of the first recessed portion is provided with a first mounting hole;
a top patch connected to the top cover and located on a side of the end cover assembly away from interior of the secondary battery;
an electrode terminal, wherein at least part of the electrode terminal is sleeved in the first mounting hole, and a protruding height of an upper surface of the electrode terminal relative to the top patch is H1, where 0<H1≤2 mm;
a second fixing member that sleeves on the electrode terminal, wherein the second fixing member is made of an insulating material;
a connection sheet, located on a side of the top cover away from the electrode terminal, and connected to the electrode terminal; and
a sealing member, arranged along a circumferential direction of the electrode terminal;
wherein the end cover assembly further comprises a first fixing member, the first fixing member sleeves on the second fixing member and is welded to the top cover to limit the electrode terminal, the electrode terminal and the first fixing member are located on two sides of the second fixing member respectively, the electrode terminal comprises a main body and a flange, the flange is arranged along a circumferential direction of the main body, the second fixing member abuts against the flange, the connection sheet comprises a protruding portion, the protruding portion protrudes towards the electrode terminal and passes through the first mounting hole to be connected to the electrode terminal, or the electrode terminal is mounted to the top cover through a third fixing member, the third fixing member is located on a side of the top cover away from the top patch and sleeves on the electrode terminal, the second fixing member is arranged on a side of the top cover facing the top patch and extends into the first recessed portion, the second fixing member comprises an extending portion, the extending portion extends along a thickness direction of the end cover assembly and is arranged along the circumferential direction of the electrode terminal, and at least part of the extending portion extends into the first mounting hole and is located between the electrode terminal and a hole wall of the first mounting hole.

20. An energy storage box, comprising an inverter, a battery management system, and at least one battery pack, wherein the battery pack is the battery pack according to claim 19.
